(19) United States
(12) Patent Application Publication
(10) Pub. No.: US 2012/0279994 A1
(43) Pub. Date: Nov. 8, 2012

(54) Combination cleaning solution and towel dispenser

(76) Inventor: Danial Iver Depper, Kelowna (CA)

(21) Appl. No.: 13/067,075

(22) Filed: May 6, 2011

(51) Int. Cl. B67D 1/07

(52) U.S. Cl. 222/192

(57) ABSTRACT

A combination cleaning solution and absorbent towel dispenser includes a substantially parallel pair of elongate hollow tubes wherein the tubes are adjacent one another and joined along a common seam therebetween. Each tube has a closed base end and an opposite, open end. One tube has a diameter sized to snugly fit therein an elongate container containing cleaning solution so that the container is held by a friction fit and is selectively removable therefrom by sliding the container from the open end of the first tube. The second tube is sized to store therein a plurality of absorbent towels and includes a slot formed in a sidewall thereof for dispensing therethrough the towels one at a time. A removable cap is mounted onto the open end of the tube containing the towels.

### FIELD OF THE INVENTION

This invention relates to the field of devices for dispensing cleaning solutions while simultaneously providing convenient access to absorbent towels, and in particular to a combination cleaning solution and towel dispenser.

### BACKGROUND OF THE INVENTION

Many enclosures, and notably the inside of vehicles, require periodic cleaning. In the example of a vehicle, the inside of a vehicle becomes dusty and often soiled, and an oily film becomes deposited the inside of the windshield due to no more than conventional use of the vehicle. Occasionally, especially where the driver of the vehicle is inclined to eat or drink in the vehicle while driving, spills will occur inside the vehicle which also require cleaning.

In any particular vehicle a number of different objects will conventionally be found stowed somewhere in the vehicle. For example, vehicles will conventionally carry a spare tire, a user manual, and sometimes a cell phone charger, a first aid kit, and sometimes also a box of facial tissue, and also sometimes a container of for example pre-moistened sanitizing wipes. If the vehicle is used for commercial purposes, for example is a truck which is driven daily, the operator of the truck will also often have rags or other cloth wipes for wiping the hands of the operator and may also carry a container of degreaser or other solvent. However, in applicant's experience, which applicant believes may be extrapolated to the experience of drivers of many types of vehicles and for use in many other applications, it would be convenient for the operators of commercial vehicles to have to hand a compact highly portable container in which an easily used spray solvent is contained along side an easily accessed holding compartment containing absorbent towels, whether of paper or other absorbent material.

Thus it is an object to provide such a combination of a cleaning solution dispenser and an absorbent towel dispenser which protects the cleaning solution container and the towels while maintaining them in close proximity and protected in a unitary housing. Thus when cleaning is required the combination device may be easily located and will provide a high likelihood that, once the device is located within the vehicle, both the cleaning solution dispenser will correctly operate and the towels will correctly dispense and that both the solution in its dispenser and the towels will not come to harm by being loosely stowed or even for example stepped on or dropped while in the vehicle or other stowage location.

### SUMMARY OF THE INVENTION

In summary the combination cleaning solution and absorbent towel dispenser as described herein may be characterized in one aspect as including a substantially parallel pair of elongate hollow tubes comprising a first tube and a second tube, wherein the first and second tubes are adjacent one another and joined along a common seam therebetween. Each tube has a closed base end and an opposite, open, upper end defined by a corresponding rim.

The first tube has a first diameter and is sized to snugly fit therein an elongate container containing cleaning solution so that the container is held by a friction fit in the first tube and is selectively removable therefrom by sliding the container from the open end of the first tube. The second tube has a second diameter and is sized to store therein a plurality of the absorbent towels. The second tube includes a slot formed in a sidewall thereof. The slot extends from substantially the base end of the second tube to the open end of the second tube and sized for dispensing therethrough the towels one at a time from the plurality of towels stored in the second tube. The dispenser further includes a removable cap mountable onto the open end of the second tube.

The base ends of the two tubes may be substantially flat and co-planar so that the dispenser may be stood up on its base end. The height of the first tube is shorter than the tube and cap combination of the second tube so as to allow for the height of a cap on the cleaning solution container. It is intended that, with a container of cleaning solution inserted fully into the first tube, that the container spray nozzle, pump handle assembly, etcetera will protrude above the rim of the first tube but will be shorter than the top of the cap on the second tube so that the cap on the second tube protects the spray nozzle pump handle assembly, etcetera on the container held in the first tube. Thus, the open end of the first tube is set-down from, that is, lower than, an uppermost end of the second tube cap when mounted on the open end of the second tube.

In a preferred embodiment the first and second tubes are cylindrical so as to snugly fit therein respectively a cylindrical container of cleaning solution and a roll of absorbent towels. The tubes may however be other than cylindrical, for example they may be square in cross-section.

Advantageously the slot is substantially parallel to the common seam. The common seam may be a rigid seam or wall (collectively referred to herein as the common seam) extending substantially the entire length of the first tube. The slot may be a lower slot and an upper slot may be provided which is formed in the second tube cap so that when the cap is mounted on the open end of the second tube the upper and lower slots are aligned. In one embodiment the set-down distance of the open end of the first tube from the upper-most end of the cap when mounted on the open end of the second tube is substantially equal to the first diameter, that is, the diameter of the front tube, so as to protect a nozzle or spray head, etcetera (collectively herein a nozzle) on an upper end of the container of cleaning solution when mounted in the first tube.

An elongate spindle may be provided which is mounted centrally in and along the second tube for mounting thereon of a roll of the absorbent towels. The spindle may be substantially parallel to the slot.

A dispensing flange may be mounted to the second tube so as to extend along the slot so that the dispensing flange partially covers over the slot. The dispensing flange may be angled relative to the slot so as to be substantially tangentially aligned with an adjacent sidewall of the second tube. Advantageously the flange is substantially rigid and has a substantially linear edge parallel to the slot and distal from the second tube, whereby a single towel may be drawn across the linear edge to separate the single towel from a roll of towels in the second tube. The flange may be angled toward the first tube.

### BRIEF DESCRIPTION OF THE DRAWINGS

FIG. 1 is, in front perspective view, the cleaning solution and absorbent towel dispenser combination as described herein.

FIG. 2 is, in front elevation view, the dispenser of FIG. 1.

FIG. 3 is a vertical section through the center of the pair of tubes of the dispenser of FIG. 2.

FIG. 4 is a plan view of the dispenser of FIG. 2.

FIG. 5 is a section view along line 5-5 in FIG. 3.

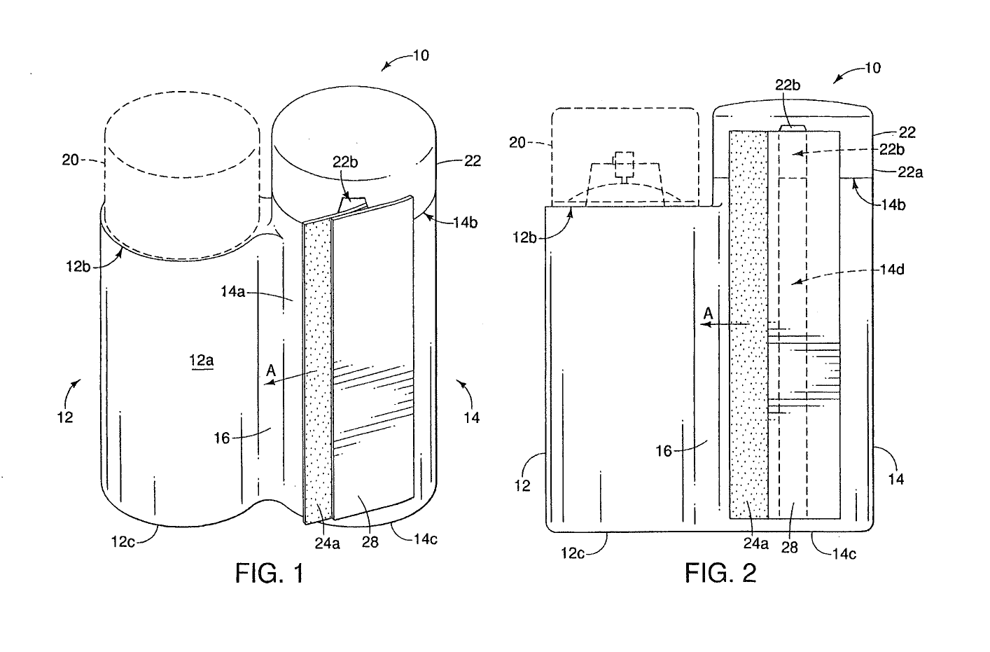

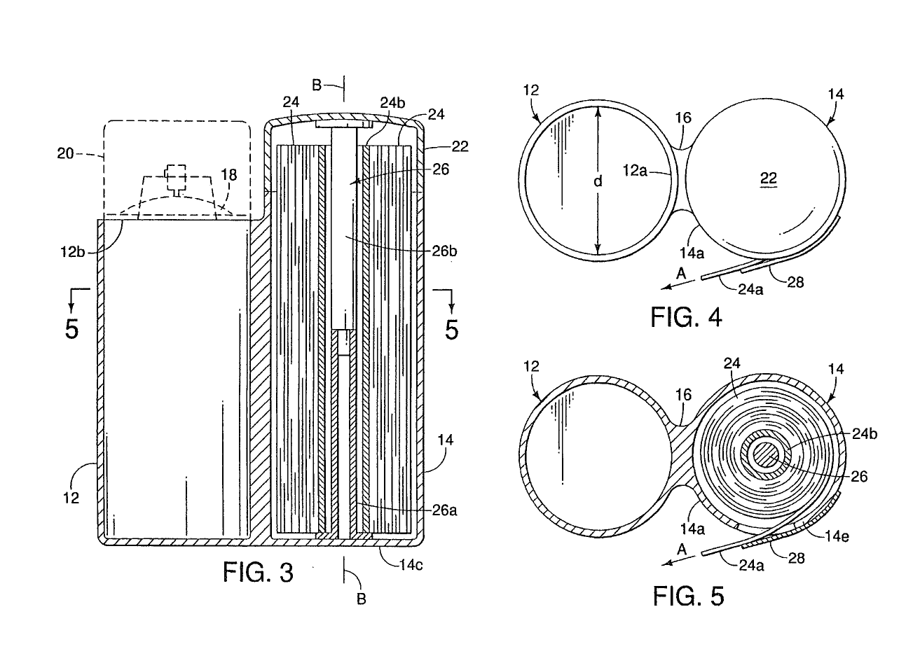

### DETAILED DESCRIPTION OF EMBODIMENTS OF THE INVENTION

As seen in the accompanying figures wherein like reference numerals denote corresponding parts in each view, the dispenser 10 according to a preferred embodiment which is not intended to be limiting includes two parallel hollow cylindrical tubes 12 and 14 adjoined along a common seam 16 so that the side wall 12a of a first tube 12 is firmly affixed to the opposed-facing sidewall 14a of the second tube 14. The two tubes may be of substantially the same material, such as thin-walled plastic, and may have substantially the same lateral diameters “d”. Common seam 16 may be of the same material as tubes 12 and 14, for example also may be of plastic, although this is not intending to be limiting as many forms of attachment between tubes 12 and 14 will work so long as tubes 12 and 14 remain a unitary structure while in use and for storage so that a user will always have the cleaning solution and a supply of towels readily to hand and located together.

An aerosol can 18 (shown in dotted outline), which may also be a pump nozzle bottle or other elongate cylindrical container holding cleaning solution and which has a manually operable dispenser for dispensing the cleaning solution, mounts snugly into and along the full length of tube 12. Cap 20, also shown in dotted outline, may be the conventional cap typically packaged with conventional aerosol cans and pump nozzle spray bottles, or may be a separate cap which has been sized and designed specifically to mount on the upper opening into tube 12. The upper rim 12b of tube 12 defines the upper opening into tube 12 and is generally horizontal when tubes 12 and 14 are standing upright on their co-planar base ends 12c and 14c respectively. Rim 12b is at a lower elevation than the top surface of cap 22 by a distance substantially equal to the height of cap 20. Thus the top of cap 20 is substantially on the same elevation as the top of cap 22.

Cap 22 is formed as an integral part of tube 14 and is releasably mountable onto the opening of tube 14 defined upper rim 14b by means which would be known to one skilled in the art. For example, cap 22 may be threaded down onto a correspondingly threaded rim 14b, or for example, cap 22 may be sized for an overlapping friction fit where the lower rim 22a of cap 22 slides snugly over rim 14b of tube 14. This latter embodiment is illustrated although not intended to be limiting.

When cap 22 is fully seated onto rim 14b, a slot 22b in cap 22 aligns with a vertical slot 14d, shown in dotted outline in FIG. 2, in the side wall of tube 14.

A cylindrical cartridge of absorbent towels 24, for example paper towels rolled into a cylinder, are removably stored within tube 14 and cap 22. The cartridge of absorbent towels 24 may be formed as a single rolled sheet wherein individual towels are separated by perforations allowing a single towel sheet 24a to be detached from the remaining towels in the roll as the single sheet 24a is dispensed in direction A through aligned slot 14d in tube 14 and its corresponding slot 22b in cap 22. The cartridge of towels 24 do not have to be a single roll of paper towels separated by perforations, as other forms of towel storage within tube 14 would also work as would be known to one skilled in the art. For example the cartridge of towels may be comprised of separate paper or cloth towels, for example stored in a pleated fashion, or for example separate towels could be formed as a roll wrapped around a central axis of cylindrical symmetry B.

Where towels 24 are stored as a roll within tube 14 a center spindle 26 may be employed to assist in smooth dispensing of towels 24 and so as to inhibit a jamming of the towels within the tube. In the illustrated embodiment, spindle 26 has a base end 26a mounted down onto base 14c within tube 14 and an upper, mating, spindle end 26b mounted to the inside of the upper surface of cap 22 so that, with cap 22 mounted onto tube 14, the upper and lower spindle portions 26a and 26b mount onto one another to form a single elongate spindle 26 extending the entire distance of the internal cavity of tube 14 and cap 22. In one embodiment, not intended to be limiting, towels 24 may be rolled on a tubular sleeve 24b which may for example be a cardboard tube which supports the roll of towels 24 on spindle 26 so as to, again, inhibit binding of the towels within the tube when the towels are being dispensed.

In one embodiment, advantageously, a towel dispenser flange 28 extends from side wall portion 14e of tube 14 so as to cover over slot 14d, and in the illustrated embodiment also to cover over at least a portion of slot 22b on cap 22. Although not intending to be limiting, in the illustrated embodiment, flange 28 is a generally planar flexible sheet which has been affixed to side wall portion 14e of tube 14, for example by adhesive. Flange 28 may also usefully be formed as a unitary part of tube 14 so as to cover over slot 14d and alternatively also to extend vertically upwardly so as to cover over slot 22b. Flange 28 does not entirely close over the slots but rather is angled over the slots so as to leave an opening through which towels 24 may be dispensed in direction A. Again, flange 28 provides for ease of dispensing of the towels from the towel roll, inhibits binding and also provides a firm distal edge against and across which the towels may be separated from one another for example in the embodiment where the roll of towels are a single rolled sheet of paper towels separated from one another by perforations.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A combination cleaning solutions and absorbent towel dispenser comprising:
a substantially parallel pair of elongate hollow tubes comprising a first tube and a second tube, wherein said first and second tubes are adjacent one another and joined along a common seam therebetween, each tube of said first and second tubes having a closed base end and an opposite, open, upper end,
wherein said first tube has a first diameter and is sized to snugly fit therein a container containing the cleaning solution so that the container is held by a friction fit in said first tube and is selectively removable therefrom by sliding the container from said open end of said first tube,
and wherein said second tube has a second diameter and is sized to store therein a plurality of the absorbent towels, and wherein said second tube includes a slot formed in a sidewall thereof, said slot extending from substantially said base end of said second tube to said open end of said second tube and sized for dispensing therethrough the towels one at a time from the plurality of towels stored in said second tube, said dispenser further comprising a removable cap mountable onto said open end of said second tube,
and wherein said base ends are substantially co-planar and wherein said open end of said first tube is set-down from an uppermost end of said cap when mounted on said open end of said second tube.

2. The dispenser of claim 1 wherein said first and second tubes are cylindrical so as to snugly fit therein a cylindrical container of the cleaning solution and a roll of the absorbent towels.

3. The dispenser of claim 2 wherein said slot is substantially parallel to said common seam, and wherein said common seam is a rigid seam extending substantially the entire length of said first tube.

4. The dispenser of claim 3 wherein said set-down of said open end of said first tube from said upper-most end of said cap when mounted on said open end of said second tube is of a set-down distance substantially equal to said first diameter so as to protect a nozzle on an upper end of the container of cleaning solution when mounted in said first tube.

5. The dispenser of claim 2 further comprising an elongate spindle mounted centrally in and along said second tube for mounting of a roll of the absorbent towels onto said spindle, and wherein said spindle is substantially parallel to said slot.

6. The dispenser of claim 1 wherein said slot is a lower slot and wherein an upper slot is formed in said cap so that when said cap is mounted on said open end of said second tube said upper and lower slots are aligned.

7. The dispenser of claim 1 further comprising a dispensing flange mounted to said second tube so as to extend along said slot, wherein said dispensing flange partially covers over said slot.

8. The dispenser of claim 7 wherein said dispensing flange is angled relative to said slot so as to be substantially tangentially aligned with an adjacent sidewall of said second tube.

9. The dispenser of claim 8 wherein said flange is rigid and has a substantially linear edge parallel to said slot and distal from said second tube, whereby a single towel may be drawn across said linear edge to separate the single towel from a roll of towels in said second tube.

10. The dispenser of claim 9 wherein said flange is angled toward said first tube.
